(19) United States
(12) Patent Application Publication
(10) Pub. No.: US 2012/0164324 A1
(43) Pub. Date: Jun. 28, 2012

(54) SELF-PASSIVATING PROTECTIVE COATINGS

(75) Inventors: BRENT ALLEN CLOTHIER, Clifton Park, NY (US); Lawrence Barnard Kool, Clifton Park, NY (US)

(73) Assignee: GENERAL ELECTRIC COMPANY, SCHENECTADY, NY (US)

(21) Appl. No.: 12/978,075

(22) Filed: Dec. 23, 2010

(51) Int. Cl. B05D 3/02; B05D 7/22

(52) U.S. Cl. 427/226; 427/239

(57) ABSTRACT

In one aspect, the present invention provides a method of protecting a metal vessel susceptible to corrosion by hydrogen sulfide, the method comprising: (a) applying a coating composition comprising a metal oxide precursor material, a solid metal oxide, and a solvent to a surface of the metal vessel to be protected; (b) converting at least a portion of the metal oxide precursor material to a metal oxide, and removing at least a portion of the solvent to provide a metal oxide layer disposed on the surface of the metal vessel; and (c) converting at least a portion of the metal oxide layer to a corresponding metal sulfide layer or a metal oxysulfide layer.

### BACKGROUND

The present invention relates to the protection of metal surfaces from the corrosive effects of hydrogen sulfide. In a particular aspect, the present invention relates to barrier layers which can be used to protect especially sensitive portions of metal vessels used in the hydrocarbon refining.

Many oil refinery operations process hydrocarbon streams that contain hydrogen sulfide (H₂5), at times referred to as “sour gas”. Vessels and conduits in these operations are susceptible to H₂S-induced stress corrosion, especially at heat-affected zones (HAZ's) near weld lines (or weld seams). This is particularly the case since refinery vessels and conduits are typically constructed from mild steels due to their low cost and availability in high-volume. In many instances, vessels and conduits used in a refinery and susceptible to exposure to hydrogen sulfide are fabricated from standard, relatively low cost steel articles (i.e., plates, tubes, etc.) via welding, a process that creates a so-called “heat affected zone” (HAZ) in the region of the weld. Given the high susceptibility of such HAZ's to H₂S-induced stress-corrosion cracking, steps must be taken in order to protect such portions of a pipe or vessel from exposure to hydrogen sulfide during use.

Various coatings have been applied over the surface of such HAZ's in order to create a protective barrier separating the hydrogen sulfide-sensitive surface from hydrogen sulfide-containing process fluids. Conventional coating strategies have employed organic composite resins such as epoxy resins containing inorganic fillers that improve H₂S resistance. Such composite coatings, however, demonstrate insufficient service lifetimes, necessitating frequent removal and re-application. Furthermore, organic composite coatings are intolerant of high-temperature steam-out processes (i.e., T>200° C.) commonly used to clean out hydrocarbon residues in refineries. High temperature steam has been demonstrated in conventional coating embodiments to induce blistering, cracking, or even complete delamination of organic composite coatings.

Notwithstanding the considerable effort and ingenuity expended to date in this area, further improvements are desirable. This disclosure details the creation and use of various essentially inorganic coatings which are believed to offer advantages in terms of coating service lifetime and enhanced operational robustness.

### BRIEF DESCRIPTION

In one aspect, the present invention provides a method of protecting a metal vessel susceptible to corrosion by hydrogen sulfide, the method comprising: (a) applying a coating composition comprising a metal oxide precursor material, a solid metal oxide, and a solvent to a surface of the metal vessel to be protected; (b) converting at least a portion of the metal oxide precursor material to a metal oxide, and removing at least a portion of the solvent to provide a metal oxide layer disposed on the surface of the metal vessel; and (c) converting at least a portion of the metal oxide layer to a corresponding metal sulfide layer or a metal oxysulfide layer.

In another aspect, the present invention provides a method of protecting a metal vessel susceptible to corrosion by hydrogen sulfide, the method comprising: (a) applying a coating composition comprising a zinc oxide precursor material, solid zinc oxide, and an organic solvent to a surface of the metal vessel to be protected; (b) converting at least a portion of the zinc oxide precursor material to a zinc oxide, and removing at least a portion of the solvent to provide a zinc oxide layer disposed on the surface of the metal vessel; and (c) converting at least a portion of the zinc oxide layer to a corresponding zinc sulfide layer or a zinc oxysulfide layer.

In yet another aspect, the present invention provides a method of protecting a metal vessel susceptible to corrosion by hydrogen sulfide, the method comprising: (a) applying a coating composition comprising a metal oxide precursor material, a first solid metal oxide, a second solid metal oxide, and an organic solvent to a surface of the metal vessel to be protected; (b) converting at least a portion of the metal oxide precursor material to a metal oxide, and removing at least a portion of the solvent to provide a metal oxide layer disposed on the surface of the metal vessel; and (c) converting at least a portion of the metal oxide layer to a corresponding metal sulfide layer or a metal oxysulfide layer.

Other embodiments, aspects, features, and advantages of the invention will become apparent to those of ordinary skill in the art from the following detailed description and the appended claims.

### DETAILED DESCRIPTION

In the following specification and the claims which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “solvent” can refer to a single solvent or a mixture of solvents.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

As discussed in detail below, the present invention provides a method of protecting a metal vessel susceptible to corrosion by hydrogen sulfide (at times herein referred to as the metal substrate, or simply the substrate). The method is particularly suitable for use in industrial settings wherein the vessel contains heat affected zones (HAZs) such as weld lines (or seams) which are especially sensitive to the corrosive effects of hydrogen sulfide (H₂S) at moderately high temperature. The metal vessel may be, for example, a conduit such as a metal pipe used to transport a refinery gas stream containing hydrogen sulfide; or the metal vessel may be a reaction vessel, for example a stirred tank reactor of the type encountered in various industrial settings. It is stressed that the methods provided by the present invention may be used on any surface (interior or exterior) which may be susceptible to corrosion by hydrogen sulfide.

In one embodiment, the method of the present invention works by coating an interior surface of a refinery vessel with a metal oxide layer which is relatively reactive with hydrogen sulfide. Sour gas (i.e., H₂S) dissolved in a hydrocarbon stream present in the vessel reacts with the coating's exposed surface, forming an outer sulfide or oxysulfide layer. In various embodiments, this transformed layer is both inert to further reaction with hydrogen sulfide and inhibits hydrogen sulfide diffusion to the vessel surface beneath. Thus, in one aspect, the method provided by the present invention relies upon a metal oxide layer which is reactive with hydrogen sulfide, and upon reaction with hydrogen sulfide forms a barrier layer which resists the transmission of hydrogen sulfide across it. The metal oxide layer is conceived of as self-passivating in that its reactivity toward further reaction with hydrogen sulfide is diminished over time in the presence of hydrogen sulfide. Yet, its barrier properties with respect to the transmission of hydrogen sulfide are enhanced as a function of the extent to which the metal oxide layer has been converted to the corresponding sulfide or oxysulfide barrier layer.

Metal oxide layers suitable for use in the practice of the present invention comprise metal oxides which form sulfide layers or oxysulfide layers which are resistant to the transmission of hydrogen sulfide even across a relatively thin section of a sulfide barrier layer or an oxysulfide barrier layer formed from the metal oxide layer. Other metal oxide layers which are suitable for use in the practice of the present invention include metal oxide layers which form more porous (with respect to hydrogen sulfide transmission) sulfide or oxysulfide barrier layers, but are characterized by sulfidation kinetics sufficiently slow to prevent the complete consumption of oxide during the coating's desired lifetime, and yet sufficiently fast to consume an effective amount of the hydrogen sulfide present and thereby protect the underlying metal substrate.

Metal oxide layers which meet these criteria are typically based upon metal oxides susceptible to reaction with hydrogen sulfide, and may include vanadium oxide, chromium oxide, nickel oxide, zinc oxide, molybdenum oxide, silver oxide, tin oxide, like metal oxides, and mixtures containing two or more of the foregoing metal oxides. In some instances, metal oxide layers containing simple binary oxides (e.g. ZnO) are preferred due to their simple implementation and lower costs. However, multi-component metal oxide compositions may also serve as the basis for the metal oxide layer, provided the multi-component metal oxide composition meets the aforementioned criteria. Non-limiting examples of multi-component metal oxide compositions include zinc-iron oxide compositions, zinc-cobalt oxide compositions, zinc-titanium oxide compositions, and so forth.

Those of ordinary skill in the art will understand that the metal oxide layers must be relatively thick, typically greater than 10 microns in thickness, in order to protect the underlying substrate using the self-passivation strategy disclosed herein. The preparation of relatively thick, dimensionally stable, and largely crack-free metal oxide layers on the surface of the metal vessel to be protected constitutes an important and especially challenging aspect of the present invention, as such surfaces may or may not be flat, and may be in locations not directly accessible by human operators.

In one embodiment, formation of the metal oxide layer on the surface of the metal vessel to be protected is achieved via a modified “sol-gel” process in which a “sol” (also at times herein referred to as a coating composition) is sprayed or painted onto the surface of the substrate. The “sol” is transformed into a “gel” as solvent present in the sol evaporates. Thereafter, the “gel” disposed upon a surface of a metal vessel to be protected is transformed into a metal oxide layer. In one embodiment, a gel disposed upon the surface of the metal vessel is transformed into a metal oxide layer coating using steam. The sol-gel protocol creates metal oxide layers that are conformal to the surface of the metal vessel to be protected, dense, pore-free, and crack-free; features needed to optimize protection of the underlying substrate. The sol-gel process may also produce metal oxide layers with direct chemical bonding to the surface of the metal vessel to be protected. For example a metal oxide layer produced using the method of the present invention may form a direct chemical bond to the native oxide surface of a steel vessel. This property may provide high adhesive strength and thereby prevent delamination of the protective coating during temperature and pressure cycling.

As noted, in various embodiments, a coating composition comprising a metal oxide precursor material, a solid metal oxide and a solvent are applied to the surface of the metal vessel to be protected. The metal oxide precursor material is by definition susceptible to conversion to the corresponding metal oxide. For example, the metal oxide precursor material may be a metal derivative which upon reaction with water forms the corresponding metal oxide, as is the case of zinc acetate (Zn(Ac)₂) and tetraethyl orthosilicate (EtO)₄Si. In an alternate embodiment, the metal oxide precursor material is a metal derivative which may be transformed into a metal oxide without the intervention of water, for example a metal oxalate. In one embodiment, the metal oxide precursor material is susceptible to conversion to one or more transition metal oxides. In one embodiment, the metal oxide precursor material is susceptible to conversion to one or more metal oxides selected from the group consisting of vanadium oxide, chromium oxide, nickel oxide, zinc oxide, molybdenum oxide, silver oxide, tin oxide, titanium oxide and combinations of two or more of the foregoing metal oxides. Suitable transition metal oxide precursor materials are illustrated by the C₁-C₉ carboxylates of one or more of the foregoing metals. As mentioned, the metal oxide precursor material may be susceptible to conversion to a single metal oxide, for example zinc oxide.

The solid metal oxide present in the coating composition may be related to the metal oxide precursor material as its “corresponding metal oxide”, or it may be unrelated to the metal oxide precursor material. The role of the solid metal oxide is to provide metal oxide-rich ceramic oxide coatings of sufficient thickness and dimensional stability to be useful. Suitable solid metal oxides include transition metal oxides. In one embodiment, the solid metal oxide is selected from the group consisting of vanadium oxide, chromium oxide, nickel oxide, zinc oxide, molybdenum oxide, silver oxide, tin oxide, and combinations of two or more of the foregoing metal oxides. In an alternate embodiment, the solid metal oxide is zinc oxide. In certain embodiments, it is advantageous to employ a solid metal oxide having a uniform particle size distribution. In one embodiment, the solid metal oxide present in the coating composition may comprise a nanoparticulate metal oxide.

As noted, the coating composition comprises the metal oxide precursor material, the solid metal oxide and a solvent. Suitable solvents include solvents in which the metal oxide precursor material is sufficiently soluble to create a sol comprising the metal oxide precursor material, the solid metal oxide and the solvent; and yet which solvents are sufficiently volatile to enable transformation of the sol to a gel upon its application to the surface of the metal vessel to be protected. In one embodiment the solvent is a relatively non-polar solvent such as an aromatic hydrocarbon such as toluene or xyxlene. In an alternate embodiment, the solvent is a relatively polar solvent such as an aliphatic alcohol, for example ethanol. In one embodiment the solvent is selected from the group consisting of hydrocarbons, alcohols, ethers, esters, amines, amides, nitriles, and combinations of two or more of the foregoing solvent types.

As noted, the coating composition used in the practice of the present invention has a paint-like consistency and comprises a metal oxide precursor material, a solid metal oxide, and a solvent. In one embodiment, the metal oxide precursor material is present in an amount corresponding to from about 0.1 mole to about 2.0 moles of metal oxide precursor material per liter of solvent present in the coating composition. In an alternate embodiment, the metal oxide precursor material is present in an amount corresponding to from about 0.5 mole to about 1.5 moles of metal oxide precursor material per liter of solvent present in the coating composition. The solid metal oxide is typically present in an amount corresponding to from about 5 percent by weight to about 80 percent by weight of the coating composition. Various additives may be used to keep the coating composition reasonably homogeneous during use.

As noted, the coating composition is applied to the surface of the metal vessel to be protected and forms a coating thereupon. Typically, the coating composition is applied to a heat affected zone of the vessel such as a weld line (or weld seam) and an adjacent portion of the surface of the metal vessel. Thus, the coating composition may be applied to a hydrogen sulfide-sensitive weld line having a certain width (w₁) in such a manner that the resultant coating disposed on the weld line has a width (w₂) which is greater than width w₁. Typically the width of the coating w₂ is designed so that the entire heat affected zone of the weld line and any hydrogen sulfide-sensitive adjacent portions of the vessel are coated. Typically, adequate protection of the heat affected zone may be achieved when the width of the coating w₂ is in a range from about 2 times w₁ to about 100 times w₁.

The coating composition may be deposited on the surface of the metal vessel to be protected as a single layer or as multiple layers to afford an initial coating layer comprising the metal oxide precursor material, the solid metal oxide and at least a portion of the coating composition solvent. As noted, in various embodiments, at least a portion of the solvent initially present in the coating composition is separated from the coating composition during its application to the surface of the metal vessel to be protected. This separation can take place, for example, by evaporation or entrainment, but is important in that it increases the viscosity of the coating composition such that it adheres well to the surface to which it is applied prior to further transformation. The coating composition is applied such that the initial coating layer has a thickness sufficient to afford a sufficiently thick, self-passivating metal oxide layer to protect the underlying substrate surface. In one embodiment, the initial coating layer has a thickness in a range from about 20 microns to about 2000 microns. In an alternate embodiment, the initial coating layer has a thickness in a range from about 50 microns to about 1500 microns.

Following deposition of the coating composition on the surface of the metal vessel to be protected, at least a portion of the metal oxide precursor material is converted to the corresponding metal oxide and at least a portion of the solvent present in the initial coating layer is removed. Such conversion of the metal oxide precursor material and removal of solvent may be accomplished by heating the initial coating layer to a temperature in a range between about 100° C. and about 600° C., in one embodiment in a range from about 100° C. to about 400° C., and in yet another embodiment in a range from about 100° C. to about 250° C. In various embodiments, such heating is carried out in the presence of water vapor, for example steam or steam mixed with another gas such as nitrogen gas. In certain embodiments, solvent removal and conversion of the metal oxide precursor material take place in essentially discrete steps. For example, most of the solvent may be removed following deposition of the coating composition in a relatively low temperature-low moisture drying step, followed by a separate conversion of the metal oxide precursor material to metal oxide.

In one embodiment, the initial coating layer is converted to a metal oxide layer disposed on the surface of the metal vessel by heating the coating composition disposed on the surface of the metal vessel to a temperature in a range from about 50° C. to about to about 300° C. in the presence of moisture. As noted, the moisture may be provided by steam or another source of water.

In one embodiment, the metal oxide layer has a thickness in a range from about 10 microns to about 1000 microns. In an alternate embodiment, the metal oxide layer has a thickness in a range from about 20 microns to about 500 microns. In yet another embodiment, the metal oxide layer has a thickness in a range from about 40 microns to about 250 microns. As noted, the metal oxide layer provided as taught herein is typically conformal to the surface of the substrate to which it is applied, is free of cracks, adheres strongly to the surface of the substrate, and is of relatively uniform thickness.

The metal oxide layer produced by conversion of at least a portion of the metal oxide precursor material in the initial coating layer to the corresponding metal oxide, and the removal of at least a portion of solvent from the initial coating layer provides the metal oxide layer which upon exposure to hydrogen sulfide reacts to form a metal sulfide layer or a metal oxysulfide layer. In one embodiment, at least a portion of the metal oxide layer is converted to the corresponding metal sulfide layer or metal oxysulfide layer by exposing the metal oxide layer to an atmosphere comprising hydrogen sulfide at a temperature in a range from about 100° C. to about to about 300° C. Such exposure may be carried out as part of a vessel manufacturing process itself, or may be carried out in situ during use of the vessel. Thus, for example, a vessel which is a pipe having one or more hydrogen sulfide-sensitive weld lines (or weld seams) may be manufactured and treated according to the method of the present invention prior to its actual use to provide a pipe in which weld lines (or weld seams) are protected from subsequent exposure to hydrogen sulfide by a metal sulfide layer or a metal oxysulfide layer. Alternatively, a vessel which is a pipe having one or more hydrogen sulfide-sensitive weld lines (or weld seams) may be manufactured and treated according to the method of the present invention to provide a pipe in which weld lines (or weld seams) are coated with a metal oxide layer which upon installation and use will undergo exposure to hydrogen sulfide and subsequent reaction to form a protective metal sulfide- or metal oxysulfide layer during he working lifetime of the pipe. In one embodiment, the method of the present invention may be used in the context of vessel repair or reconfiguration wherein the acts associated with the repair or reconfiguration process produce hydrogen sulfide-sensitive zones and surfaces within the vessel. For example, the repair or reconfiguration of a vessel may involve the creation of hydrogen sulfide-sensitive weld lines (or weld seams) at a vessel surface which may later be exposed to significant amounts of hydrogen sulfide.

As noted, since the metal oxide layer is relatively thick, the metal sulfide layer or metal oxysulfide layer may be limited to the outer surface of the metal oxide layer exposed to hydrogen sulfide. Thus in one embodiment, a portion of the metal oxide layer constituting the outer 10 microns or so of the metal oxide layer is converted to a metal sulfide layer or a metal oxysulfide layer and seals the remaining underlying metal oxide layer from further exposure to hydrogen sulfide. In an alternate embodiment, nearly the entire metal oxide layer from the surface of the metal oxide layer in contact with the substrate to the outermost surface of the metal oxide layer is converted to a metal sulfide layer or a metal oxysulfide layer.

In a one embodiment the present invention provides a method of protecting a metal vessel susceptible to corrosion by hydrogen sulfide, the method comprising: (a) applying a coating composition comprising a zinc oxide precursor material, solid zinc oxide, and an organic solvent to a surface of the metal vessel to be protected; (b) converting at least a portion of the zinc oxide precursor material to a zinc oxide, and removing at least a portion of the solvent to provide a zinc oxide layer disposed on the surface of the metal vessel; and (c) converting at least a portion of the zinc oxide layer to a corresponding zinc sulfide layer or a zinc oxysulfide layer.

In another embodiment, the present invention provides a method of protecting a metal vessel susceptible to corrosion by hydrogen sulfide, the method comprising: (a) applying a coating composition comprising a metal oxide precursor material, a first solid metal oxide, a second solid metal oxide, and an organic solvent to a surface of the metal vessel to be protected; (b) converting at least a portion of the metal oxide precursor material to a metal oxide, and removing at least a portion of the solvent to provide a metal oxide layer disposed on the surface of the metal vessel; and (c) converting at least a portion of the metal oxide layer to a corresponding metal sulfide layer or a metal oxysulfide layer. In a specific embodiment the first solid metal oxide is zinc oxide and the second solid metal oxide is titanium oxide.

The coating composition may be applied to the surface of the metal vessel to be protected using any of a number of techniques known to those skilled in the art, for example spraying, brush coating, dip coating, and the like. Those of ordinary skill in the art will appreciate that a variety of equipment and techniques are available for applying coatings such as the coating compositions used in the present invention to the interior of vessels not directly accessible by a human operator, for example a weld line on the interior of a pipe to which access is limited to in-pipe coating composition application. Thus, in one embodiment the coating composition is applied via a rotary sprayer adapted to fit within the interior of a pipe and configured to apply the coating composition to a particular surface of the interior of the pipe.

### Experimental Section

Methods employing “sols” for the deposition of zinc oxide (ZnO) as relatively thin film thickness (i.e., less than 1 μm) are known in the art. However, the present invention contemplates the use of sol-based coating compositions which are brushed or sprayed in relatively thick layers (i.e., greater than 10 μm) onto substrates requiring protection. Accordingly, the sol system of Ohyama, et al.—originally developed for electronic and optical thin films—was modified to produce a suspension capable of drying into a pore- and crack-free coating (Ohyama, M.; Hiromitsu, K.; Yoko, T. Sol-gel Preparation of ZnO Films with Extremely Preferred Orientation along (002) Plane from Zinc Acetate Solution. Thin Solid Films 1997, 306 (1), 78-850.) As will be appreciated by those of ordinary skill in the art, the system taught by Ohyama, et al. is merely representative and that the present invention may be practiced using other modified or newly-developed sols as well.

### Example 1

To create the necessary solvent, 140.95 mL of 2-methoxyethanol was pre-mixed with 9.05 mL (0.15 mol) of monoethanolamine and transferred into a two-necked flask equipped with a Schlenk-style PTFE valve. The quantity of monoethanolamine was specifically selected to produce a 1:1 molar ratio with the zinc acetate precursor (i.e., added next).

Then, 32.93 g (0.15 mol) of zinc oxide precursor zinc acetate dihydrate was added into the hybrid solvent, creating a 1.0 M solution with respect to the total volume. The two-necked flask was sealed (i.e., necks stoppered and valve closed) and the solution was heated at 60° C. for 2 hours under stirring. During this process, the zinc oxide precursor dissolved, generating a transparent and colorless sol.

Solid zinc oxide was sieved through a −150 nylon mesh screen to generate a fine, non-aggregated powder. A 30-mL aliquot of the aforementioned sol was transferred to a glass jar via syringe. 4-5 g portions of the sieved zinc oxide powder were added, under stirring, until a total of 24 grams of solid zinc oxide had been added. The jar was closed and the suspension manually agitated with strong side-to-side motion. The dispersion of the resulting paint-like coating composition was excellent with no visible settling for at least an hour.

The coating composition was then added to the dispensing bottle of an airbrush and sprayed onto mild carbon steel substrates at 40-50 psig. Atomization of the fluid and forced convection during transit induced solvent evaporation, creating sticky, sol-coated particulates that readily adhered the surface of the steel substrate. The as-sprayed coatings exhibited no cracking after drying.

To complete the curing of the gelled sol by converting at least a portion of the metal oxide precursor material (zinc acetate) to zinc oxide, the dried coatings were placed into an autoclave and exposed to steam at 365° F. and 150 psi. This final process produced mild steel substrates with thick ZnO coatings capable of self-passivation when exposed to H₂S. A variety of art recognized methods for the conversion of zinc oxide coatings to zinc sulfide or zinc oxysulfide coatings are known those of ordinary skill in the art.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A method of protecting a metal vessel susceptible to corrosion by hydrogen sulfide, the method comprising:
(a) applying a coating composition comprising a metal oxide precursor material, a solid metal oxide, and a solvent to a surface of the metal vessel to be protected;
(b) converting at least a portion of the metal oxide precursor material to a metal oxide, and removing at least a portion of the solvent to provide a metal oxide layer disposed on the surface of the metal vessel; and
(c) converting at least a portion of the metal oxide layer to a corresponding metal sulfide layer or a metal oxysulfide layer.

2. The method according to claim 1, wherein the metal oxide precursor material is susceptible to conversion to one or more transition metal oxides.

3. The method according to claim 1, wherein the metal oxide precursor material is susceptible to conversion to one or more metal oxides selected from the group consisting of vanadium oxide, chromium oxide, nickel oxide, zinc oxide, molybdenum oxide, silver oxide, tin oxide, titanium oxide and combinations of two or more of the foregoing metal oxides.

4. The method according to claim 1, wherein the metal oxide precursor material is susceptible to conversion to zinc oxide.

5. The method according to claim 1, wherein the solid metal oxide comprises one or more transition metal oxides.

6. The method according to claim 1, wherein the solid metal oxide is selected from the group consisting of vanadium oxide, chromium oxide, nickel oxide, zinc oxide, molybdenum oxide, silver oxide, tin oxide, and combinations of two or more of the foregoing metal oxides.

7. The method according to claim 1, wherein the solid metal oxide is zinc oxide.

8. The method according to claim 1, wherein the solid metal oxide is a nanoparticulate metal oxide.

9. The method according to claim 1, wherein the solvent is selected from the group consisting of hydrocarbons, alcohols, ethers, esters, amines, amides, nitriles, and combinations of two or more of the foregoing solvent types.

10. The method according to claim 1, wherein said converting in step (b) comprises heating the coating composition on the surface of the metal vessel to a temperature in a range from about 50° C. to about to about 300° C. in the presence of moisture.

11. The method according to claim 1, wherein said converting in step (b) comprises heating the coating composition on the surface of the metal vessel in the presence of steam.

12. The method according to claim 1, wherein the metal oxide layer disposed on the surface of the metal vessel has a thickness in a range from about 10 to about 1000 microns.

13. The method according to claim 1, wherein said converting in step (c) is carried out by exposing the metal oxide layer disposed on the surface of the metal vessel to an atmosphere comprising hydrogen sulfide at a temperature in a range from about 100° C. to about to about 300° C.

14. The method according to claim 13, wherein said converting in step (c) is carried out in situ.

15. A method of protecting a metal vessel susceptible to corrosion by hydrogen sulfide, the method comprising:
(a) applying a coating composition comprising a zinc oxide precursor material, solid zinc oxide, and an organic solvent to a surface of the metal vessel to be protected;
(b) converting at least a portion of the zinc oxide precursor material to a zinc oxide, and removing at least a portion of the solvent to provide a zinc oxide layer disposed on the surface of the metal vessel; and
(c) converting at least a portion of the zinc oxide layer to a corresponding zinc sulfide layer or a zinc oxysulfide layer.

16. The method according to claim 15, wherein said zinc oxide precursor material comprises a C₁-C₉ zinc carboxylate.

17. The method according to claim 16, wherein said zinc oxide precursor material comprises zinc acetate.

18. The method according to claim 15, wherein said applying is carried out by spray coating.

19. The method according to claim 15, wherein said applying is carried out by brush coating.

20. The method according to claim 15, wherein said converting in step (c) is carried out by exposing the zinc oxide layer disposed on the surface of the metal vessel to an atmosphere comprising hydrogen sulfide at a temperature in a range from about 100° C. to about to about 300° C.

21. The method according to claim 20, wherein said converting in step (c) is carried out in situ.

22. A method of protecting a metal vessel susceptible to corrosion by hydrogen sulfide, the method comprising:
(a) applying a coating composition comprising a metal oxide precursor material, a first solid metal oxide, a second solid metal oxide, and an organic solvent to a surface of the metal vessel to be protected;
(b) converting at least a portion of the metal oxide precursor material to a metal oxide, and removing at least a portion of the solvent to provide a metal oxide layer disposed on the surface of the metal vessel; and
(c) converting at least a portion of the metal oxide layer to a corresponding metal sulfide layer or a metal oxysulfide layer.

23. The method according to claim 22, wherein the first solid metal oxide is zinc oxide and the second metal oxide is titanium oxide.

24. The method according to claim 22, wherein the first and second metal oxides are nanoparticulate metal oxides.

25. The method according to claim 22, wherein the metal oxide precursor material is susceptible to conversion to zinc oxide.
